(19) United States
(12) Patent Application Publication
(10) Pub. No.: US 2005/0007997 A1
(43) Pub. Date: Jan. 13, 2005

(54) Distributed control method and system to route flows on netwowrks

(76) Inventors: Blaise Morton, Minnetonka, MN (US); Yi-Ju Chao, Minnetonka, MN (US)

Correspondence Address: Blaise Morton, 15345 Woodside Lane, Minnetonka, MN, 55345, US

(21) Appl. No.: 10/616,653

(22) Filed: Jul. 9, 2003

(51) Int. Cl. H04L 12/28

(52) U.S. Cl. 370/351; 370/395.31

(57) ABSTRACT

The present invention discloses a distributed control method and system for routing message flows on a network. Each node locally computes a routing table and cooperatively exchanges control information to achieve network stability, robustness and acyclic flows. This distributed control method introduces potential functions for each class of messages to each target nodes, defined on the network nodes for determining the routes of message flows. The difference of potentials for messages of a class between a pair of neighbor nodes represents the direction and the quantity of the message flow that should be sent between the pair of neighbor nodes. Each node performs the disclosed method by, first, delivering exogenous input information for each message class to the target nodes of the messages, secondly, computing potential values for all message classes, and finally, each node computing a routing table based on the potential differences to those of its neighbor nodes and/or weights on its neighbor links.

### TECHNICAL FIELD

The present invention relates to control of network systems, for example, communications systems, computer systems, command and control systems. In particular, the present invention relates to a control system and method that adopts a routing methodology to keep network operation in a range of specified performance.

### BACKGROUND

We consider routing of messages in different types of network systems. One example is an Internet Administrative Domain operated by a carrier or an operator, in which the messages of voice, web-browses, or multimedia services may be routed. Another example is a computer network system where messages are exchanged between different workstations. A network may also be a command and control system composed of multiple servers, where the servers cooperatively exchange information between each other in order to control a client system. These types of networks are abstracted into the graph model in FIG. 1 for the sake of explanation of the present invention.

FIG. 1 shows a graphical model of a typical network structure. Messages are communicated within the network, wherein a message (10) is a unit delivered on links. Depending on different practices, a message may also be called a cell, a frame, a packet, or a data block, etc. Each node (30) represents a set of receivers, buffers, processors and transmitters, which are working together as a unit for receiving messages, identifying their destinations, and sending them to other nodes. Each link (20) of the graph represents a communication channel of some sort, for example, wire, fiber optic cable, wireless link, by which messages may be delivered from one node to another. The absence of a link between any pair of nodes means that messages may not be delivered directly between them, while the presence of a link indicates that messages may be delivered between them.

Still referring to FIG. 1, we now consider the passage of a string of messages through the network. The node where the message string enters into the network is its source node as shown in (40) or (50), and where the message string leaves from the network is its target node as shown in (45) or (55). The message string takes routes (a sequence of links connected by sequential nodes) from its source node to its target node. On the routes, nodes other than the source node and the target node are routers for the message string as shown in (60). Messages of different types, for example, voice, web-browses, or multimedia services, are often put into different classes of messages subject to different requirements; for example, requirements on bounds of delay, minimal packet-drop rates, and data rates. For the sake of explanation of the present invention, we distinguish messages of different classes by their target nodes as well as their different requirements.

In a packet-switched network, a message enters the network without a pre-defined route to its destination node. The packets are tagged with their final destinations, but the decision regarding to which path a message should follow is made at each node along the way. The current methodology of routing messages by using the shortest-path routing algorithm has some shortcomings that need be addressed. First, the shortest path is often not the most efficient path to transport a message from its source node to its destination node. Secondly, the physical property of network elements, such as transmitters, links, receivers, buffers and processors, impose limitations on the achievable nominal performance of the network. These limitations may result in traffic congestion along the shortest path.

No matter what types of controls are implemented, it is highly desirable to ensure the network operates in steady states, where network steady states mean that the states of the network, for example, input rates, output rates, buffer occupancies, will not become large enough to exceed the hardware and software limitations. It is furthermore desirable to use control to operate the network within a specific range of states because the range reflects the requirements on hardware and software sizes. The larger the range is allowed, the more expensive the hardware and software may be.

There are many challenges for networks controls, for example, unpredictable data inputs causing congestion at nodes, uncertainties of network operation such as link failures, distributed network topology adding difficulties, etc. In addition, it is also highly desirable to control message routes through the network in a distributed fashion, which means that each node locally computes desired control algorithm, and only requires local information and limited information from the rest of the network. The distributed control is motivated by several reasons. For example, in many applications, network nodes are geographically distributed. Once a link fails, a distributed control, compared to a centralized one, tends to limit the problem locally and prevents the problem from spreading and affecting the rest of the network. A distributed control also facilitates plug and play of new network nodes; in this case, less reconfiguration is required in comparison to a centralized one. Another motivation is to reduce computational redundancy and complexity because information required for a distributed control is usually much less than a centralized one.

There are challenges for distributed control, including keeping the network operating in steady states, and robustness of the control methodology. Especially, in the context of network routing problems, it is challenging to keep network flows acyclic, which means the messages do not travel around loops. Thus, what is needed for effective message routing is a distributed control system that is capable of accommodating variable network topology, traffic patterns, and physical hardware properties in order to keep the network operating within a range of specified performance requirements and also to achieve robustness and acyclic flows.

### SUMMARY

The present invention discloses a distributed control method and system to route message flows through a network. Each node locally computes a routing table and cooperatively exchanges control information to achieve network stability, robustness and acyclic flows.

One key ingredient of this methodology is the introduction of potential functions, defined on the network nodes to help determine the routes selected for messages of a class. Basically, the difference of potentials for messages of a class between a pair of neighbor nodes represents the direction and the quantity of messages of the class that should be sent between them.

The disclosed control method includes the following steps. The method delivers exogenous input information for a class of messages from its source node to its target nodes. Each node locally computes the potential values for all classes of messages, then the difference of potential values between two neighbor nodes is used to decide the direction and amount of flow between them. The method determines weights on links to represent performance parameters of interest. Each node locally computes a routing table based on the potential differences with its neighbor nodes and/or weights on its neighbor links.

A system for routing message flow on a network is disclosed as follows. Means are provided for the network to route message flows based on routing tables. Means are provided for generating and evaluating queuing information of the network nodes. Means are provided for delivering measurement information. Means for adjusting the routing tables in response to the queuing information are also provided to accommodate variation of traffic inputs and variation of network topology.

### BRIEF DESCRIPTION OF THE DRAWINGS

The present disclosure will be more clearly understood after reference to the following detailed specification is read in conjunction with the drawings, wherein:

FIG. 1 illustrates a graphical model of a network, where messages of different classes are routed and share network resources;

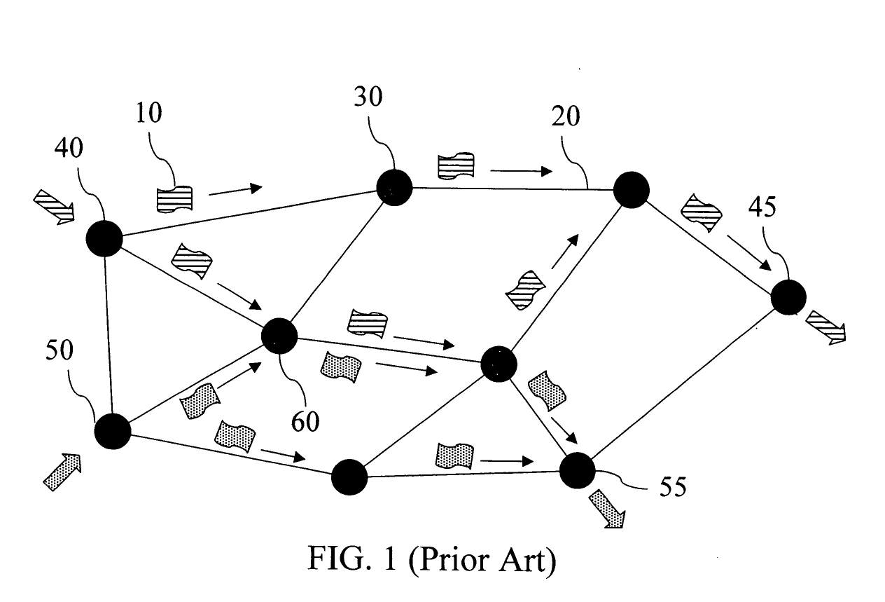

FIG. 2 illustrates the functional diagram of a closed-loop control subsystem for a node to dynamically adjust its routing table;

FIG. 3 illustrates the flow chart of an open-loop control subsystem for a node to compute its routing table;

FIG. 4 illustrates a functional diagram for a node to send the information of exogenous inputs arriving at that node, and to receive the information of exogenous inputs arriving at other nodes and targeted to that node;

FIG. 5 illustrates a method for nodes to communicate exogenous input rate information;

FIG. 6 illustrates an example to explain the set of neighbor nodes of a node;

FIG. 7 is the flow chart of a method for a node to compute the potential values for each class of messages;

FIG. 8 illustrates a method for a node to communicate potential values between its neighbor nodes;

FIG. 9 illustrates a flow chart for a node to compute a routing table;

FIG. 10 shows an example of a routing table at a node;

FIG. 11 illustrates a functional diagram for a node to send its local queue-length measurements to other nodes, and to receive measurements from other nodes;

FIG. 12 illustrates a method for a node to communicate queue-length measurements between neighbor nodes;

FIG. 13 illustrates a flow chart for a node to compute the adjustment of the routing table; and

FIG. 14 shows an example of an adjusted routing table at a node.

### DESCRIPTION OF THE PREFERRED EMBODIMENTS

The preferred embodiments of the present invention will be described with references to the figures wherein like numerals represent like elements throughout.

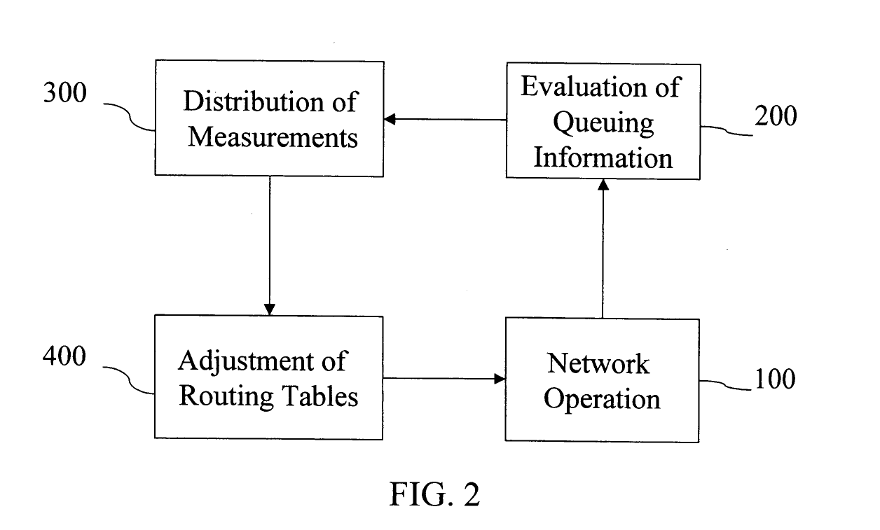

The present invention is a method for specifying a control system composed of an outer-loop control subsystem and an inner-loop control subsystem. As show in FIG. 2, an embodiment of the control system is composed of an outer-loop control subsystem that controls network operation (100) and an inner-loop subsystem including functional blocks (200), (300) and (400). The network operation (100) is controlled partly by the routing table created in the disclosed distributed method and partly other possible control mechanisms, e.g. admission control to mitigate queues that may become built up in consequence of variation of inputs and other causes. Measurements of the network state, e.g. queuing lengths of messages of different classes, are evaluated respectively in functional block (200). Different methods, e.g. linear filtering, etc. may be used in evaluation of queuing information (200), but methods to evaluate measurements are not the focus of this invention. The measurement information of each class of messages is distributed to other nodes (300), and each node receives measurement information from other nodes of the network as well. Based on the measurement information, each node creates an adjustment of routing tables (400). Note that the basic configuration of such an inner-loop and outer loop control system can be found in U.S. patent application Ser. No. 10/383,806 by Blaise Morton dated Mar. 8, 2003. Detailed descriptions of the algorithm of the functional blocks will be described in the following paragraphs.

The objectives of the disclosed control system for routing messages through networks are to keep the network operating in steady states and to achieve acyclic flows. The outer-loop control subsystem determines the nominal steady state of network flows. The inner-loop control subsystem compensates for the input variations and other uncertainties and drives the network states back toward the nominal steady state. Moreover, the control algorithm executes in a distributed fashion, where a node locally computes its routing table, and only requires local information and limited information from other nodes to achieve overall system stability and acyclic flows.

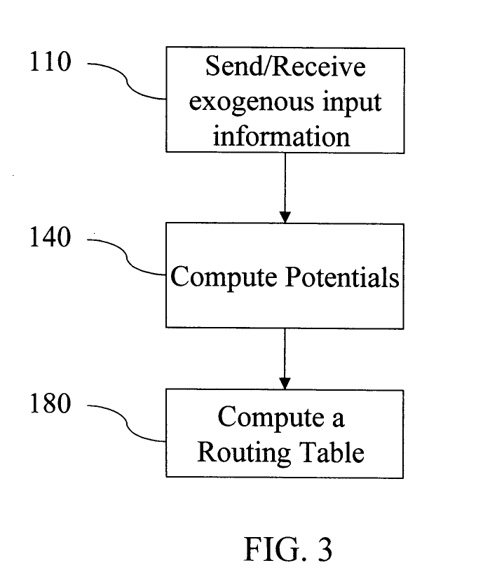

An embodiment of a method for a node to perform the outer-loop control subsystem is shown in FIG. 3. As shown in step (110), each node sends the information of exogenous inputs arriving at that node for each class of messages, and also receives the information of exogenous inputs arriving at other nodes. After step (110) is finished, the node computes the potentials for messages of each class at step (140), wherein the difference of potential values are used to decide the direction and amount of message flow between the two neighboring nodes. After finishing step (140), the node computes a routing table at step (180). Details of the steps (110), (140) and (180) will be described later.

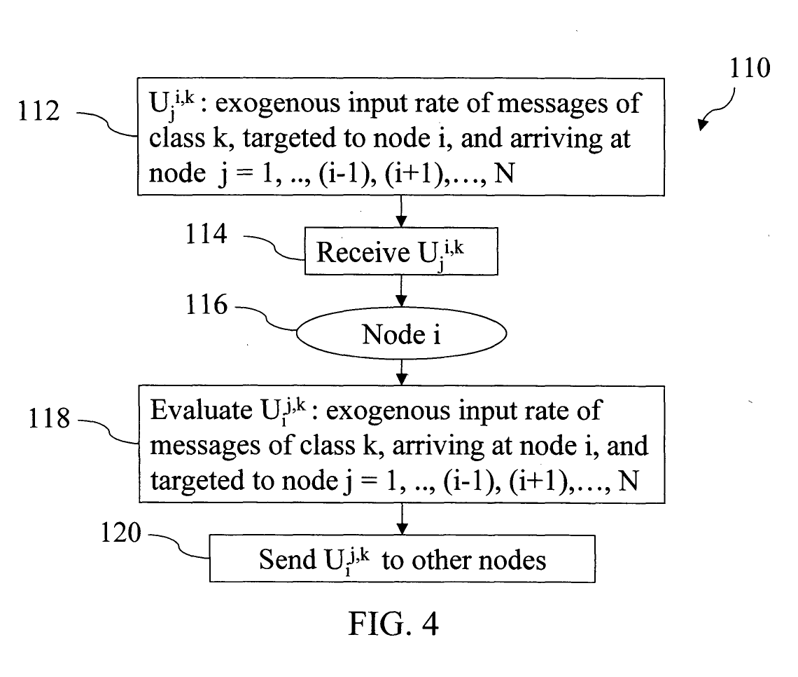

A method of functional block (110) is shown in FIG. 4. The diagram describes what kinds of input-rate information node i (116) sends and receives. At functional block (118), node i evaluates the exogenous input rates arriving at node i for each class of messages, where N−1 target nodes are assumed. We use Uᵢ^{j,k} to denote the exogenous input rate of messages of class k, arriving at node i from outside of the network, and targeted to node j. Then the node i sends the values of Uᵢ^{j,k} to other nodes as shown in functional block (120). One important point is that the information Uᵢ^{j,k} should be delivered to the node j, which means that the exogenous input rates of messages targeted to node j should be known by node j. Each node of the network independently performs the same functions as in (118) and (120) as well; therefore, node i also receives input information Uⱼ^{i,k} from other nodes as in functional block (114), where Uⱼ^{i,k} denotes the exogenous input rate of messages of class k, targeted to node i and arriving at node j from outside of the network, as defined in functional block (112).

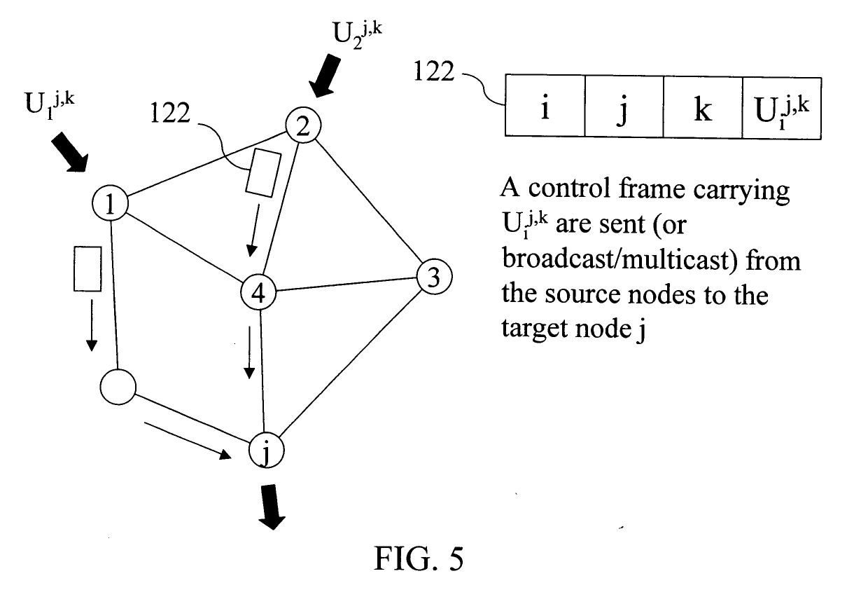

The information Uᵢ^{j,k} may be delivered by a type of control frame, containing the source node address, the target node address, the message class, and the most recent value of the input rate Uᵢ^{j,k},as shown in FIG. 5. Moreover, methods such as broadcast or multicast algorithms may be used to ensure the information Uᵢ^{j,k} will be successfully delivered from the source node i to the target node j. As described in (122), a control frame contains four fields—i is the address of the source node, j is the address of the target node, k is the message class, and Uᵢ^{j,k} is the estimated exogenous input rate of messages of class k, targeted to node j and arriving at node i.

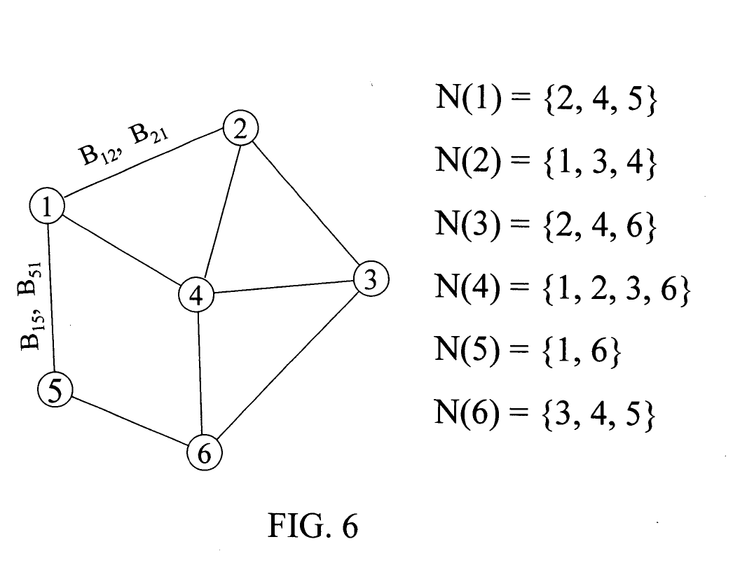

FIG. 6 introduces a parameter N(i) which denotes the set of neighboring nodes of node i. For example, the set of neighboring nodes of node 1 is N(1)={2, 4, 5}. In practice, the set of neighboring nodes of a given node represent where the given node may route messages. Each directed link from node i to node j is associated with a weight Bᵢⱼ, and in reverse a link from node j to node i is associated with a weight Bⱼᵢ. In practice, the weights represent performance parameters of interest, for example, a communication bandwidth in bits per second from node i to node j, a function of the communication bandwidth from node i to node j, estimated available bandwidth, or delay estimated between node i and node j. Alternatively, Bᵢⱼ^{k} may used to represent a weight on a directed link from node i to node j for messages of class k if different weights for different classes of messages are required. Other alternatives can also be considered such as weights adapted to different traffic loads by letting Bᵢⱼ and Bⱼᵢ be functions of network states. In conclusion, Bᵢⱼ and Bⱼᵢ are design parameters and may be selected for different implementation purposes.

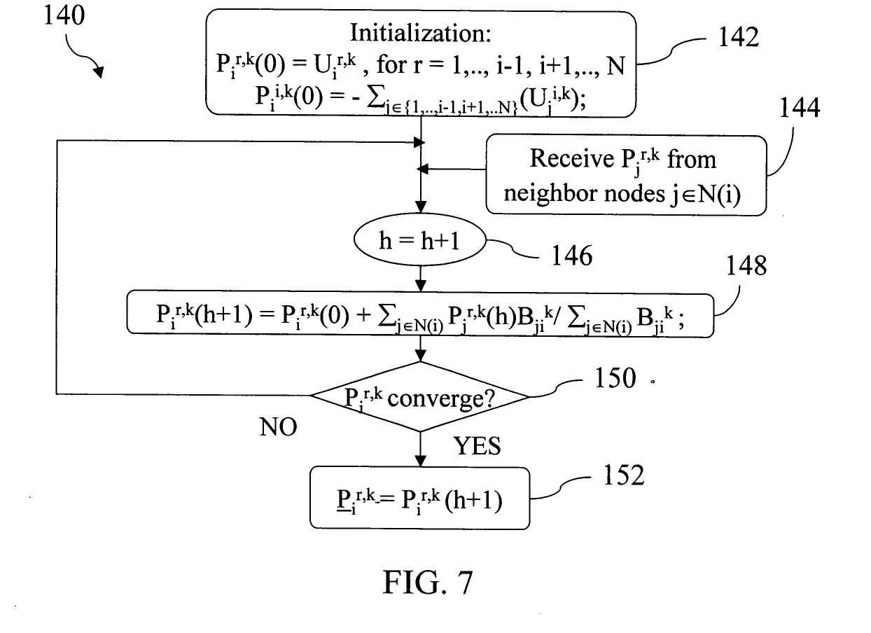

A flowchart of step (140) from FIG. 3 is shown in FIG. 7. This is an iteration method for node i to compute the potential for each class of messages. We denote Pᵢ^{r,k}(h) to be the potential value at node i for the messages of class k, targeted to node r and at the iteration step h. Step (142) shows that the initial states of the potentials are Pᵢ^{r,k}(0)=Uᵢ^{r,k} for all k, for r=1, . . . , i−1, i+1, . . . , N, and Pᵢ^{i,k} (0)=−Σ_{j∈{1, 2, . . . , i-1, i+1, . . . , N}}Uⱼ^{r,k}. At step (144) node i receives Pⱼ^{r,k}(s) from neighbor nodes j ∈N(i). The variable Pⱼ^{r,k}(s) may be sent periodically or by an event-driven trigger from the neighbor nodes, however, it is not essential for node i to know at which iteration step s the value Pⱼ^{r,k}(s) is generated. After receiving one or multiple inputs of the variables Pⱼ^{r,k}(s), node i performs the next step by updating the iteration to h+1, as shown in step (146), and then computing Pᵢ^{r,k}(h+1) based on the formula “Pᵢ^{r,k}(h+1)=Pᵢ^{r,k}(0)+Σ_{j ∈N(i)}Pⱼ^{r,k}(h) Bⱼᵢ^{k}/Σ_{j ∈N(i)}Bⱼᵢ^{k}”at step (148). Once Pᵢ^{r,k}(h+1) is computed, at step (150) some criteria are used to determine whether or not Pᵢ^{r,k}(h+1) has converged. If it has not converged, node i waits until new values of Pᵢ^{r,k}(s) arrive from neighbor nodes j ∈N(i) to perform the next iteration. If Pᵢ^{r,k}(h+1) has converged, step (152) assigns the symbol Pᵢ^{r,k} to be the converged value of Pᵢ^{r,k}(h+1), for all k and for all r. Pᵢ^{r,k} are the steady-state potentials at node i for class-k messages with target node r. Notice that flowchart (140) is performed at node i locally and only requires external information Pⱼ^{r,k}(s) from its neighbor nodes.

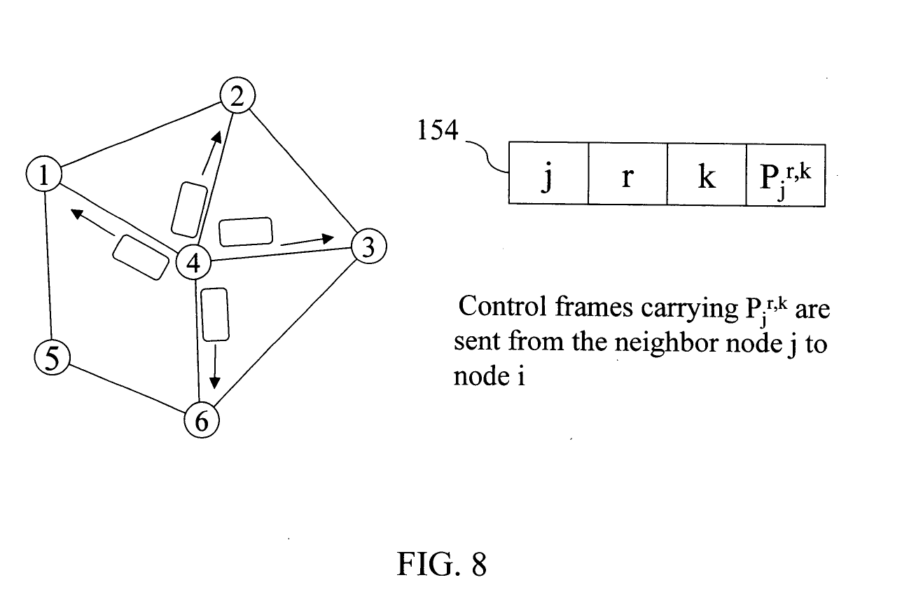

The potential value Pⱼ^{r,k}(s) is communicated between neighbor nodes through a type of control frame as shown in FIG. 8. The type of control frame (154) contains four fields—j is the node address, r is the target node address, and k is the message class, and the values Pⱼ^{r,k}(s) is the potential value. Node j may either periodically send this type of control frame or wait for an even trigged after one or several iterations of Pⱼ^{r,k} at node j.

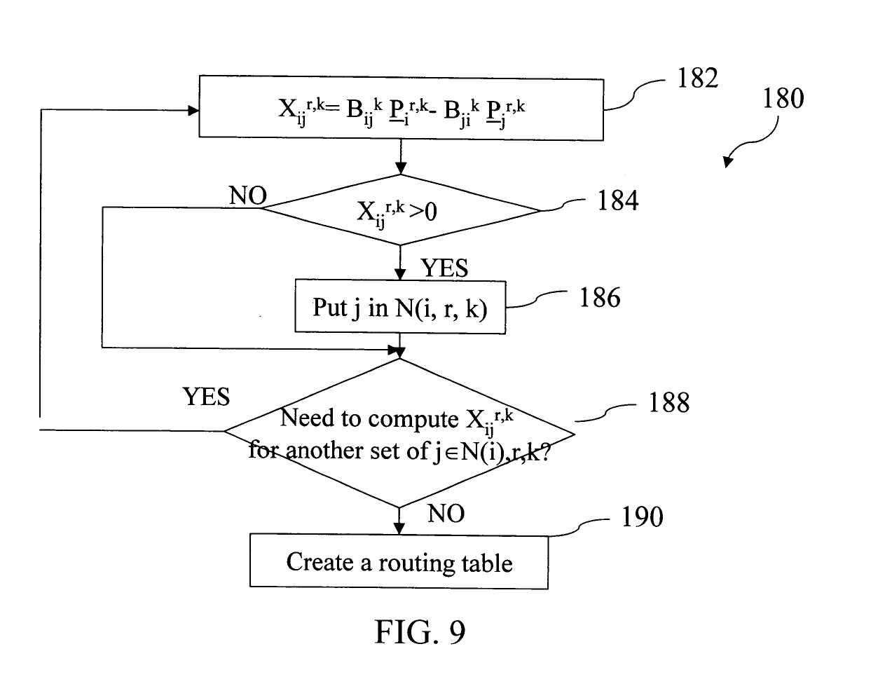

The flowchart for node i to perform step (180) of FIG. 3 is shown in FIG. 9. The flow rates Xᵢⱼ^{r,k} from node i to node j for class-k messages with target node r is computed by Xᵢⱼ^{r,k}=Bᵢⱼ^{k}Pᵢ^{r,k}−Bⱼᵢ^{k}Pᵢ^{r,k} at step (182). Step (184) decides whether or not Xᵢⱼ^{r,k} is larger than 0. If this is not, node i determines whether or not there is need to compute Xᵢⱼ^{r,k} for another set j ∈N(i), r, k at step (188). Once all the sets j ∈N(i), r, k have been examined, the algorithm creates a routing table at step (190) and then the algorithm terminates. If step (184) is true, at step (186) j is put into the set N(i, r, k), which represents the set of nodes where messages at node i, of class k, targeted to node r should be routed, and then go to step (188). The flowchart (180) is also a local algorithm which is performed in distributed fashion at each node, and does not require information from other nodes.

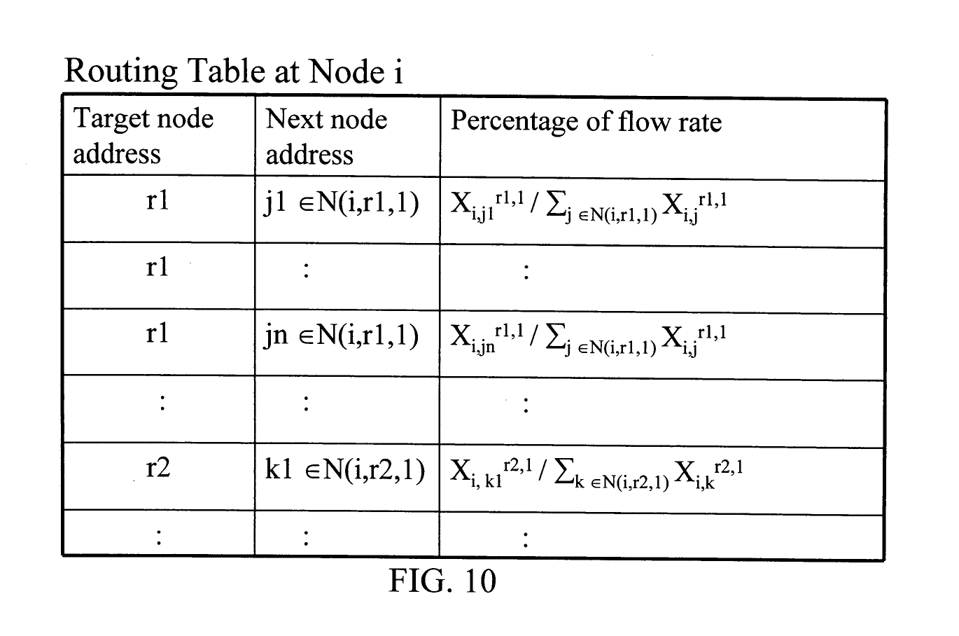

An example of a routing table at node i is shown in FIG. 10. The routing table shows there might be multiple paths for messages of the same class and the same target node. Node i reads the header information of a message, including at least (but not limited to) the target node address and the class, and then looks at the routing table to decide to which adjacent node the message should be routed next. In the routing table, the first column is the target node address, the second column is next node address, and the third column is the percentage of the message flow of the same target node and of the same class, which is the flow rate for the next node over the total flow rate. In the example of FIG. 10, there are n downstream nodes, labeled by j1, . . . , jn, for the message flow of class 1 and with target node r1. Each downstream node has a percentage of X_{i,jn}^{r1,1}/Σ_{j ∈N(i, r1, 1)}X_{i,j}^{r1,1} of the total flow rate. There are many ways to achieve the percentages in practice, for example, round robin among downstream nodes with weights representing the percentages, or random assignments of downstream nodes with weighted probability. Alternatively, messages of one flow might only be assigned to one downstream node to facilitate end-to-end in-sequence delivery of a flow. In this case, a flow identifier may be required in the header of such messages and routers should try to assign flows to different downstream nodes so that the percentages of flow rate of the routing table can be well approximated over time. In conclusion, there is a lot of flexibility to implement the routing method, but the principle is to keep the percentages of flow rates close to the ones as shown in the routing table so that the network steady states can be achieved.

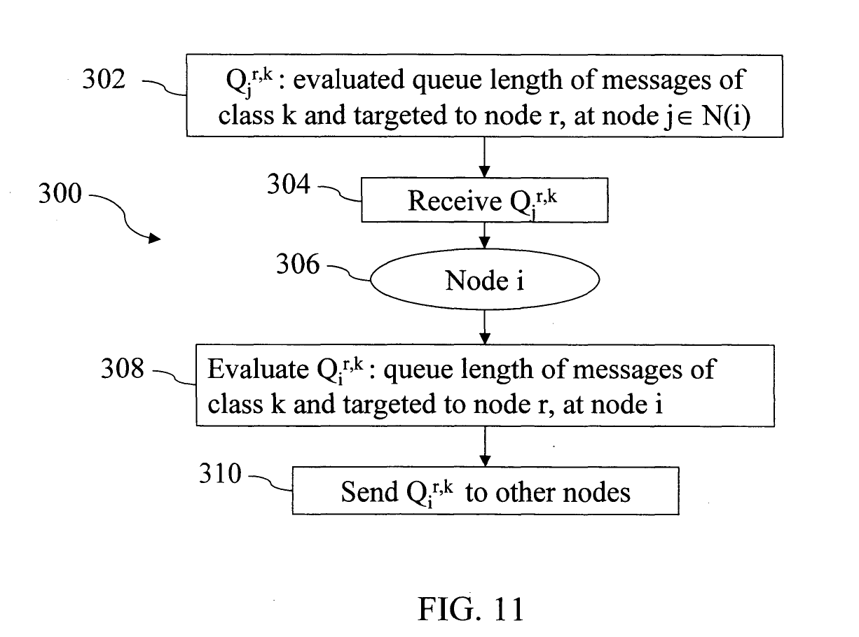

One method that could be used in functional block (300) of FIG. 2 is shown in FIG. 11. The method describes how node i (306) sends and receives measurements. Node i evaluates Qᵢ^{r,k}, where Qᵢ^{r,k} is the estimated queuing length of messages of class k, targeted to node r, at node i, as shown in step (308) Then, node i sends Qᵢ^{r,k} to its neighbor nodes as in block (310). Other nodes perform the same function as well, therefore, at block (304) node i receives Qⱼ^{r,k}, which denotes the queuing length of messages of class k, targeted to node r, and at node j, as defined in block (302). Other queuing statistics may also be used to assist network operation, for example, average queuing lengths, queuing length variations, the flow rate of an end-to-end connection, or packet-drop rates.

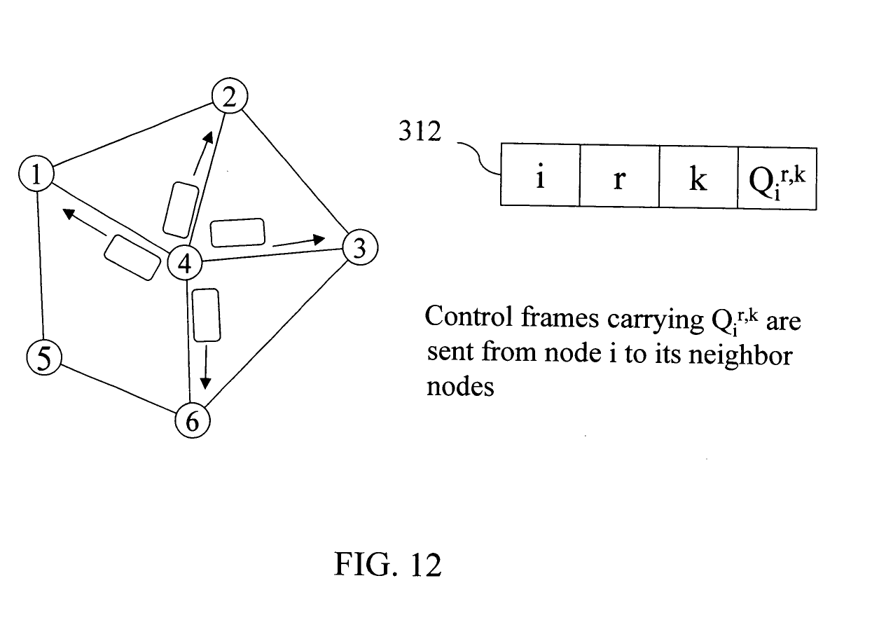

A type of control frame described in FIG. 12 may be used to send queuing length Qᵢ^{r,k} from node i to its neighboring nodes. This type of control frame (312) contains four fields—i is the node address where the queuing information is measured, r is the target node address, k is the class, and Qᵢ^{r,k} is the associated measurement.

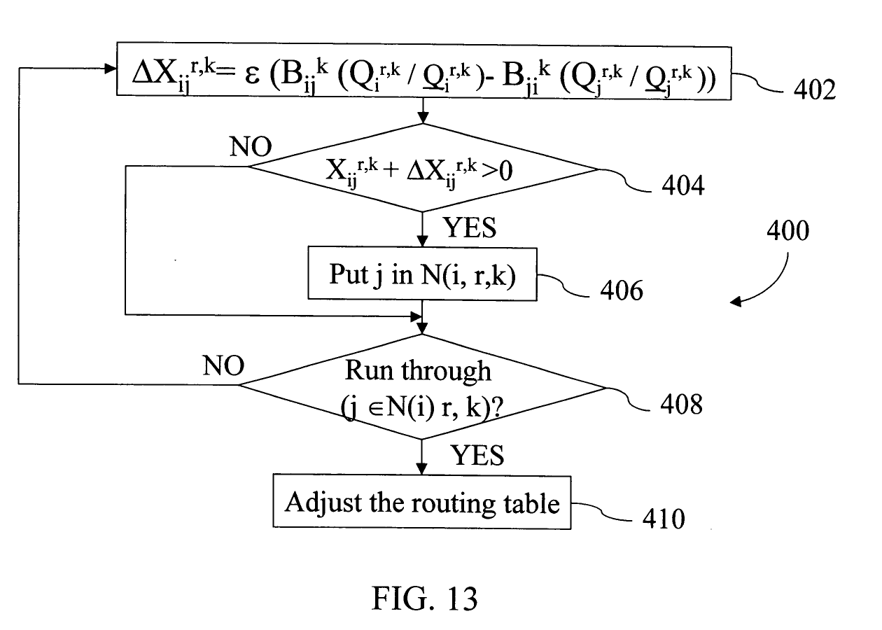

The flow chart of a method of functional block (400) of FIG. 2 is shown in FIG. 13. Step (402) computes the adjustment of the message flow rate, denoted by ΔXᵢⱼ^{r,k}, from node i to node j, of class k, targeted to node r. The flow rate adjustment is based on the formula ΔXᵢⱼ^{r,k}=ε(Bᵢⱼ^{k}(Qᵢ^{r, k}Qⱼ^{r,k})−Bⱼᵢ^{k}(Qⱼ^{r,k}/Qⱼ^{r,k})), for some ε larger than zero and where Qᵢ^{r,k} are expected queue lengths at node i for messages of class k and targeted to node r in the nominal network steady state obtained in the outer-loop control subsystem. Step (404) checks whether or not Xᵢⱼ^{r,k}+εXᵢⱼ^{r,k} is larger than zero. If it is larger than zero, step (406) puts j into the set N(i, r, k), which is the set of downstream nodes where messages of class k, targeted to node r may be routed. Then, step (408) checks whether or not the algorithm has run through all the set of (jεN(i) r, k). If the algorithm has not run through all the set of (j∈N(i), r, k), another set of (j, r, k) is chosen and then step (402) is executed again. Once the algorithm has run through all the sets of (j∈N(i), r, k), the routing table at node i is adjusted at step (410).

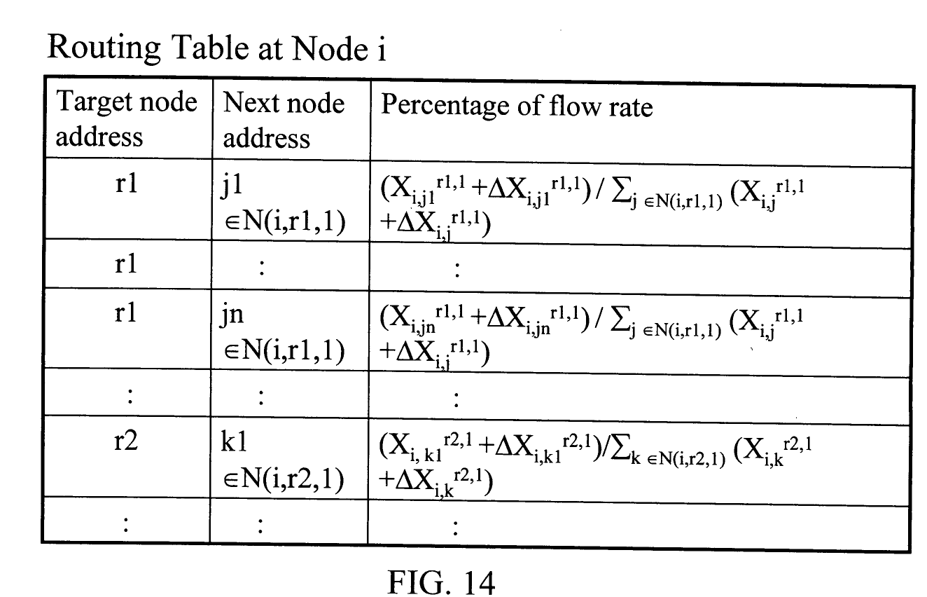

An illustration of an adjusted routing table at node i is shown in FIG. 14. The percentages of flow rates for each next node are updated by ΔXᵢⱼ^{r,k}. In the example of FIG. 14, there are n downstream nodes, labeled by j1, . . . , jn, for messages of class 1, with target node r1. The percentage of the flow rate for the downstream node j1 of class 1 is updated to (X_{i,jn}^{r1,1}+ΔX_{i,jn}^{r1,1}) /Σ_{j ∈N(i,r1,1)}(X_{i,j}^{r1,1}+ΔX_{i, j}^{r1, 1}).

This invention discloses a distributed control system and method to control message flows through a network. The disclosed method is capable of accommodating variable network topology, traffic patterns, and physical hardware properties in order to keep the network operating within a range of specified performance requirements and also to achieve robustness and acyclic flows.

The preferred embodiments and examples are merely illustrative of the present invention rather than limits to the present embodiment. As is understood by a person skilled in the art, the foregoing preferred embodiments and examples are merely illustrative of the present invention rather than limits to the present disclosure. This disclosure is intended to cover various modifications and similar arrangements included within the spirit and scope of the appended claims, the scope of which should be accorded the broadest interpretation so as to encompass all such modifications and similar structures.

1. A method for routing message flows on a network, which is composed of nodes and links, and each given node performs the method, which comprises:
delivering input information for each class of messages to the target nodes;
computing potential values for each class of messages, wherein the differences of the potential values for messages of a class to those of neighbor nodes of the given node represent the direction and the quantity of message flow of each class that are sent on neighbor links of the given node; and
computing a routing table based on the differences of the potential values to those of the neighbor nodes.

2. The method of claim 1, further comprises a step of assigning pre-determined weights on links according to performance parameters of interest.

3. The method of claim 1, wherein the step of delivering input rates for each class of messages to each target node is triggered periodically or on an event-driven basis.

4. The method of claim 1, wherein the input information of messages for each class of messages to each target node is delivered by means of broadcast or multicast algorithms via a control frame containing: a source node address, a target node address, a message class, and an estimated exogenous input rates of messages of the class.

5. The method of claim 1, wherein the step of computing potential values further includes the following steps:
initializing the potential values based on input information at the given node and received from other nodes;
iteratively receiving the potential values from the neighbor nodes of the given node; and
iteratively refining potential values of the given node, wherein an offset value based on the potential values received from the neighbor nodes is determined and the weights on the neighbor links are combined with the potential values.

6. The method of claim 1, wherein the potential value for a class of messages is delivered between two neighbor nodes through a control frame containing a source node address where the potential value is generated, the target node address where the message is targeted, the class of the messages, and the potential value.

7. The method of claim 1, wherein the step of computing a routing table further includes the following steps:
computing the difference of the potential value to those of the neighbor nodes for each class of messages and each target node, wherein the potential differences are the weighted potential values of the given node minus the weighted potential values of the neighbor nodes;
designating the neighbor node as one of downstream neighbor nodes for each class of messages to each target node, where messages of the class and with the target node are routed next, if the potential difference is larger than zero; and
creating the routing table based on the weighted potential values for each class of messages and each target node.

8. A system for routing message flows on a network in order to keep the network operating in a nominal steady state, the system comprising:
means for a node to route message flows according to routing tables created based on the differences of the weighted potential values to those of the neighbor node;
means for generating and evaluating queuing information of the network nodes;
means for delivering the queuing information between a pair of two neighbor nodes; and
means for a node to adjust its routing table in response to the queuing information to accommodate variation of traffic inputs and variation of network topology.

9. The system of claim 8, wherein the queuing information for each class of messaged for each target node is communicated between a pair of neighbor nodes through a control frame containing a source node address, a target node address, a message class, and queuing information.

10. The system of claim 8, wherein the queuing information is related to queuing length and expected queue length of the network nominal steady state.

11. The system of claim 10, wherein the means for a node to adjust the routing table adopts the following algorithm:
determining a queue-length ratio of an estimated queuing length over the expected queue length of the network nominal steady state for each message class and each target node at that node;
computing an adjusted flow rate between that node to a neighbor node to be the queue-length ratio of that node weighted by a performance parameter minus the queue-length ratio of the neighbor node also weighted by a performance parameter;
designating the neighbor node to be a downstream neighbor node for a class of messages to a target node, where messages of the class and to the target node are routed next, if the adjusted flow rate after adjustment is larger than zero; and
adjusting the routing table with the adjusted flow rates.
